(19) United States
(12) Patent Application Publication
(10) Pub. No.: US 2024/0191854 A1
(43) Pub. Date: Jun. 13, 2024

(54) LIGHTING DEVICE FOR A MOTOR VEHICLE

(71) Applicant: Hella GmbH & Co. KGaA, Lippstadt (DE)

(72) Inventors: Alfons Michaelis, Borchen (DE); Martin Mügge, Geseke (DE)

(21) Appl. No.: 18/527,983

(22) Filed: Dec. 4, 2023

(30) Foreign Application Priority Data
Dec. 12, 2022 (DE) 102022132901.1

(51) Int. Cl. F21S 41/24; F21S 41/148; F21S 41/29

(52) U.S. Cl. CPC F21S 41/24; F21S 41/148; F21S 41/29

(57) ABSTRACT

A lighting device is provided for a motor vehicle. It includes a flat waveguide that has an entry surface and at least one light emission surface. The length (L) of the waveguide is greater than 50 cm. It also includes a plurality of light sources. At least part of the light generated by the light sources enters the waveguide through the entry surface, at least part of the light entering through the entry surface exits the at least one light emission surface, and at least part of the light exiting the at least one light emission surface exits the lighting device. The lighting device also includes a device for positioning and/or retaining the waveguide. The device contains a receiver for a narrow surface of the waveguide extending along the length (L) of the waveguide.

### CROSS REFERENCE

This application claims priority to German Application No. 10 2022 132901.1, filed Dec. 12, 2022, the entirety of which is hereby incorporated by reference.

### FIELD OF THE INVENTION

The present invention relates to a lighting device for a motor vehicle.

### BACKGROUND OF THE INVENTION

Design has been a critical factor for some time for signal functions in a motor vehicle, e.g. with taillights, brake lights, turn signals or running lights in tail lamps or headlamps. The design of these lighting devices has become even more important since the introduction of LED technology, because the small light-emitting diodes, which are often used in larger numbers, can be used much more flexibly than a large incandescent lamp as the light source for signal functions, such that, in conjunction with the optical system that has been selected, there are a variety of design possibilities.

One variation on LED technology is OLED technology, in which the light source is not in the form of little dots like with light-emitting diodes, but instead is flat and larger, forming a desired light-emitting surface. A disadvantage with OLED technology is that it is much more expensive than LED technology. The reasons for these high costs are a complex production process, the different shapes required by the design, and the low quantities. In particular, the automotive industry has high requirements, such as durability when subjected to UV light and the effects of forces such as vibrations, impacts, and shaking, as well as the capacity to endure temperatures ranging from −40° C. to +85° C. or even +100° C. It is much harder for an organic light-emitting diode to satisfy these requirements than for standard light-emitting diodes.

Consequently, alternatives have been sought, with which a design can be obtained that is similar to that with organic light-emitting diodes (OLED), in particular a homogenously lit surface. This has been achieved through the use of light-emitting diodes with a flat waveguide and optical elements in the form of microstructured films or thin optical panels for diffusing the light from the waveguide. This results in a flat light module that exhibits high performance with a homogenous lighting of an entire surface area that can be of any shape or size.

Just as with organic light-emitting diodes, when integrated in a tail lamp, numerous flat light modules can be positioned next to and behind one another to obtain the desired appearance of each of the signal functions, e.g. taillights, or rear brake lights.

An exemplary flat light module is composed of front and back housing parts, which are snapped together. The front housing part can also comprise two parts, one of which is a transparent panel. There is a plate-shaped waveguide between the housing parts, with micro-optical elements, a white, diffused, reflecting film behind the waveguide, and two or three micro-optical films in front of the waveguide between the housing parts, which are responsible for the light distribution and efficiency of the system in that the individual micro-optical components are calibrated to one another. The micro-optical films can also be thin, coated optical panels.

It is only possible to obtain planar, glass elements with OLED lighting elements using current technologies, and for this reason numerous OLED lighting elements are normally used and supplemented with additional LED lighting surfaces surrounding them in order to obtain the luminosity necessary for taillights. OLED technology still cannot be used for curved surfaces, due to the high technological automotive requirements, and therefore cannot be used to obtain large surface areas for lighting devices in motor vehicles.

The technology of flat light modules with waveguides and optical panels, or optical films, in a flat housing and a cover panel can be expanded to obtain a large, flat taillight or a taillight in the form of a strip that extends across the entire, or nearly entire, width of the vehicle, that can also be curved horizontally and vertically.

The large, strip-shaped surface forms the light emission surface in the form of a continuous, coherent lighting surface, with which different signal functions can be obtained or provided. The outer shape of the taillight can be arbitrary, and does not have to be rectangular. In particular, by curving the entire lighting device, it can be shaped to fit the vehicle body, such that it can be harmonically integrated in the motor vehicle design.

With small, planar flat light modules, the components can be easily assembled and the optical components can be precisely aligned in the flat light module, in particular the waveguide for the flat light module with the LED printed circuit board.

If a very long taillamp is made of a single flat light module, with a continuous curved waveguide, it is very difficult to position the waveguide precisely in relation to the light sources, in particular in the form of light-emitting diodes, and therefore obtain an effective focusing of the light into the waveguide.

With a long, flat waveguide made of plastic, with thin walls of between 2 mm and 5 mm, for example, tensions in the waveguide or forces at attachment points can result in the waveguide not being precisely aligned with the light sources, e.g. at the ends or in the middle, thus impairing or reducing the performance of the lighting device. This can be difficult to detect through observation or measurements, because the rest of the light may be correctly focused, such that a lot of light enters the waveguide and is distributed over the entire length thereof, making it difficult to find the points where the lighting is not optimal.

### BRIEF SUMMARY OF THE INVENTION

The fundamental problem addressed by the invention is therefore to create a lighting device of the type described above, which, despite its length and curved design, is still very effective, in particular in which the lighting device enables an effective focusing of the light into a waveguide in the lighting device.

In an example embodiment, the lighting device comprises: a flat waveguide with a length, width and depth, in which the length is greater than the width, and the width is greater than the depth, in which the waveguide has an entry surface and at least one light emission surface, and the length of the waveguide is greater than 30 cm; numerous light sources, in which the lighting device is designed such that at least part of the light from the light sources enters the entry surface on the waveguide, at least part of the light entering the entry surface exits the at least one light emission surface, and at least part of the light exiting the at least one light emission surface of the waveguide exits the lighting device; and a device for positioning and/or retaining the waveguide, which has a receiver for a narrow surface of the waveguide extending along the length of the waveguide.

The positioning of the elongated waveguide in relation to the light sources can be optimized by the longitudinal receiver. This receiver ensures that light is effectively focused into the waveguide, such that a high performance can be obtained from the lighting device. The receiver can serve as both a guide for the waveguide and an assembly aid.

The length of the waveguide may be greater than 50 cm, in particular greater than 100 cm, e.g. greater than 150 cm, with the lighting device preferably designed to extend over the entire width of the motor vehicle when installed thereon. This results in a flat taillight in the form of a strip extending over the entire, or nearly the entire, width of the motor vehicle. This strip-shaped surface can form a continuous, coherent light-emitting surface that can preferably generate different signals.

The receiver can form a trough with a floor and two sides, in particular in which the floor faces the narrow surface of the waveguide, preferably with the floor bearing on the narrow surface of the waveguide. The two sides are the same height, or extend the same amount over the width of the waveguide. The rear side can also be higher than the front side. The receiver can also be geometrically adapted to an optional focusing optical element for the waveguide.

The waveguide can be curved along its length, and the receiver, in particular in the form of a trough, can be shaped to fit the curvature of the waveguide. The receiver can therefore obtain the desired, intended curvature of the waveguide over the length of the lighting device.

The waveguide can have to end surfaces, two narrow surfaces over its length, and two wide surfaces over its length, in which case the entry surface is formed by one of the narrow surfaces, and the light sources are adjacent to one another over the length of the waveguide. The at least one light emission surface can be one of the wide surfaces of the waveguide, in particular both of the wide surfaces of the waveguide extending along the length thereof.

The receiver can be placed on the narrow surface of the waveguide that also forms the entry surface. The receiver can therefore affect the positioning of the light sources in relation to the entry surface.

The light sources can be light-emitting diodes, in particular on a single printed circuit board. The device can also have at least partially white outer surfaces for positioning and/or retaining the waveguide, in particular the receiver. Because the light-emitting diodes normally have a Lambertian light distribution, thus emitting light in the entire half space, the white outer surface can be used to reflect diffused light back into the waveguide.

There can be holes in the floor of the trough-shaped receiver, in which each hole is dedicated to a light source, such that the light from each light source passes through its own hole into the entry surface on the waveguide. This allows for the light from the light sources to enter the entry surface substantially unhindered.

The receiver can determine the distance from the light sources to the entry surface on the waveguide, in particular such that this distance is between 0.1 mm and 1.0 mm, in particular between 0.2 mm and 0.5 mm. To ensure that the spacing between the light sources and the entry surface is as precise as possible, the light sources can bear in part on the floor of the receiver and/or extend into the holes in the floor of the receiver.

The lighting device can have a cover panel, in which case the lighting device is designed such that at least part of the light exiting the at least one light emission surface on the waveguide exits the lighting device through the cover panel. The cover panel can also be partially accommodated inside receiver.

The lighting device can contain at least one microstructured film and/or at least one microstructured optical panel, in which case the at least one microstructured film or at least one microstructured optical panel is also partially accommodated inside the receiver. The lighting device can also have an at least partially reflective surface on the side of the waveguide facing away from the cover panel, in which case the lighting device is designed such that the light exiting the light emission surface of the waveguide facing away from the cover panel strikes the reflecting surface, is reflected back toward the light emission surface, and at least partially reenters the waveguide before exiting the light emission surface facing the cover panel and at least partially passing through the at least one cover panel, with the reflective surface also being partially located in the trough-shaped receiver. In this manner, the lighting device can offer the high performance obtained with a flat light module through the rear reflection of the light exiting the waveguide and through targeted diffusion at the microstructured film and/or optical panel, with a homogenous lighting of the front surface. By placing the microstructured film and/or optical panel, as well as the reflective surface, in the receiver, they can be positioned and retained therein along with the waveguide.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a first embodiment of the lighting device according to the invention from above.

FIG. 2 shows a perspective view of a second embodiment of the lighting device according to the invention.

FIG. 3 shows a perspective view of a third embodiment of the lighting device according to the invention.

FIG. 4 shows a perspective view of a fourth embodiment of the lighting device according to the invention.

FIG. 5 shows the lighting device shown in FIG. 4 from another perspective.

FIG. 6 shows a perspective view of a fifth embodiment of the lighting device according to the invention.

FIG. 7 shows a part of a sixth embodiment of the lighting device according to the invention from above.

FIG. 8 shows a detail, indicated by the arrow VIII in FIG. 7.

FIG. 9 shows a partially cutaway perspective view of a seventh embodiment of the lighting device according to the invention.

FIG. 10 shows a partially cutaway side view of the lighting device shown in FIG. 9.

FIG. 11 shows a perspective view of part of the lighting device shown in FIG. 9.

FIG. 12 shows a schematic cut through the lighting device shown in FIG. 9.

FIG. 13 shows a detail indicated by the arrow XIII in FIG. 12.

### DETAILED DESCRIPTION OF THE DRAWINGS

The same reference symbols are used in the drawings for identical or functionally identical parts.

The lighting device 1 illustrated in the drawings is a tail lamp. This lighting device 1 contains numerous light sources 2 in the form of light-emitting diodes (LED) (see FIG. 8 and FIG. 13, by way of example). The numerous light-emitting diodes can also be of different colors, in order to obtain two or three signal functions, for example. These signal functions can be marker lights, running lights, and turn signals, or marker lights, running lights, and lights indicating autonomous driving, in which case the autonomous driving indication is cyan.

The lighting device also contains a flat waveguide 3. The waveguide 3 has a length L, width Q, and depth T (see FIG. 2 and FIG. 13, by way of example). The length of the waveguide 3 is significantly greater than the width Q. The width Q of the waveguide is also significantly greater than the depth T (see FIG. 2).

The length L of the waveguide 3 can be greater than 150 cm, with the lighting device 1 on the whole designed to extend over the entire, or nearly the entire, width of the motor vehicle when installed thereon.

The waveguide 3 has two end surfaces 13, 14. The waveguide 3 also has at least two narrow surfaces 4, 5 extending over its length L, that are the same width as the narrow sides of the end surfaces. The waveguide 3 also has two wide surfaces 6, 7, forming the front and back surfaces of the flat waveguide 3.

The lower narrow surface 4 when the waveguide is installed, and in the drawings, forms the entry surface 8 for the waveguide 3. The upper narrow surface 5 can also serve as an entry surface.

At least one of the wide surfaces 6, 7 of the waveguide 3 forms a light emission surface 9. Preferably, both the right and left surfaces 6, 7 in FIG. 12 form light emission surfaces 9, 10.

The light sources 2 are beneath the entry surface 8, such that the light emitted by the light sources 2 can enter the entry surface 8 (see FIG. 13). The light sources 2 are adjacent to one another along the length L of the waveguide. The light entering the entry surface 8 can spread out in the waveguide 3 and exit the waveguide 3 toward the front, or the right side in FIG. 12, as well as toward the rear, or the left side in FIG. 12, through the light emission surfaces 9, 10.

The illustrated embodiments of the lighting device 1 have a cover panel 11, through which the light exiting the light emission surface 9 can exit the lighting device 1 (see FIG. 13). The illustrated embodiments of the lighting device 1 also contain an at least partially reflective surface 12 on the side of the waveguide 3 facing away from the cover panel 11. The lighting device 1 is designed such that the light exiting the light emission surface 10 of the waveguide 3 facing away from the cover panel strikes the reflective surface 12, is reflected back to the light emission surface 10 and at least partially reenters the waveguide 3 before it exits the light emission surface 9 facing the cover panel 11, and passes through the at least one cover panel 11.

The lighting device 1 can also contain at least one (not shown) microstructured film and/or at least one (not shown) microstructured optical panel, which are placed between the waveguide 3 and the cover panel, and can homogenize the light passing through it.

The lighting device 1 also has a housing 15, which encompasses the light sources 2, the waveguide 3, the cover panel 11, and the reflective surface 12, as well as any microstructured films and/or microstructured optical panels.

Starting from a position of the entry surface 8, or light sources 2, e.g. on the lower, narrow surface 4 of the waveguide 3 along the length thereof, the upper surface of the waveguide 3 and housing 13 can have different shapes. The outer shape of the lighting device 1 in the form of a tail lamp can have any shape, and is not limited to a rectangular surface area.

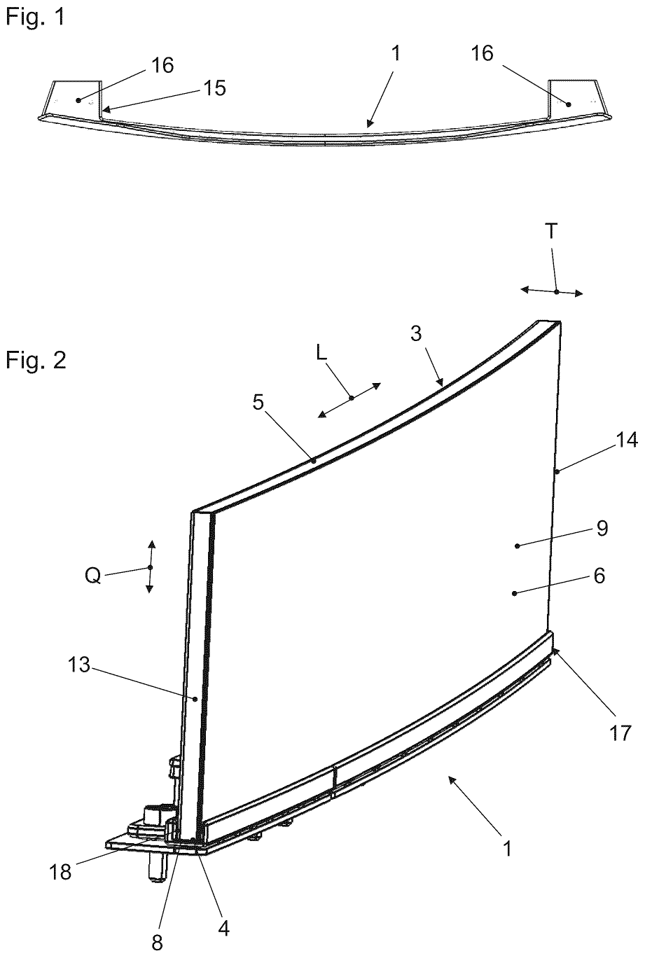

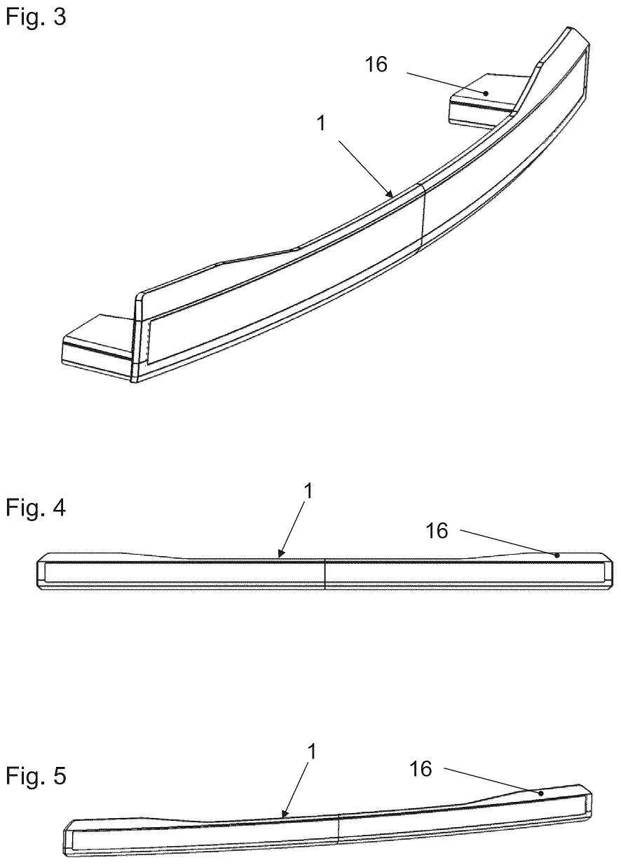

The lighting devices 1 in the first, third and fourth embodiments also have two projections 16 on the housing 15 at the ends of the waveguide 3 that extend into the motor vehicle when installed thereon (see FIG. 1 and FIGS. 3 to 5, by way of example).

The lighting device 1 also has a device 17 for positioning and/or retaining the waveguide 3, which has a receiver 18 extending along the length L of the waveguide (see FIG. 10 and FIG. 13, by way of example). The receiver 18 is in the form of a trough, with a floor 19 and two sides 21, 21. The floor 19 faces the lower, narrow surface 4, or entry surface 8, of the waveguide 3. In particular, the floor 19 bears at least in part on the narrow surface 4, or entry surface 8, of the waveguide 3 (see FIG. 10).

The two sides 20, 21 are the same height, i.e. extend to the same extent over the width of the waveguide 3, in the various exemplary embodiments shown herein. The sides 20, 21 accommodate not only the waveguide 3, but also the cover panel 11 and reflective surface 12, as well as any microstructured films and/or optical panels.

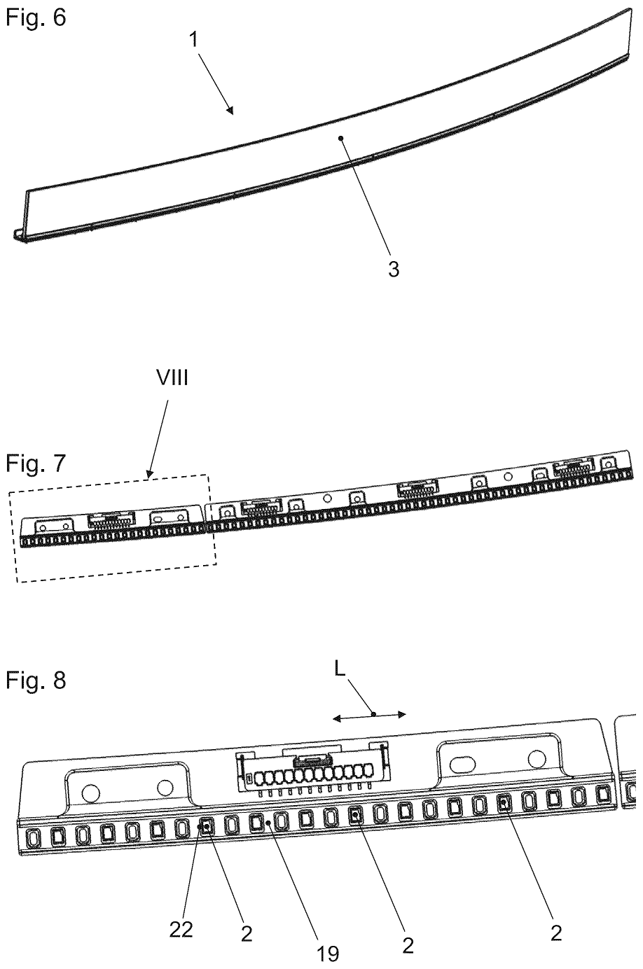

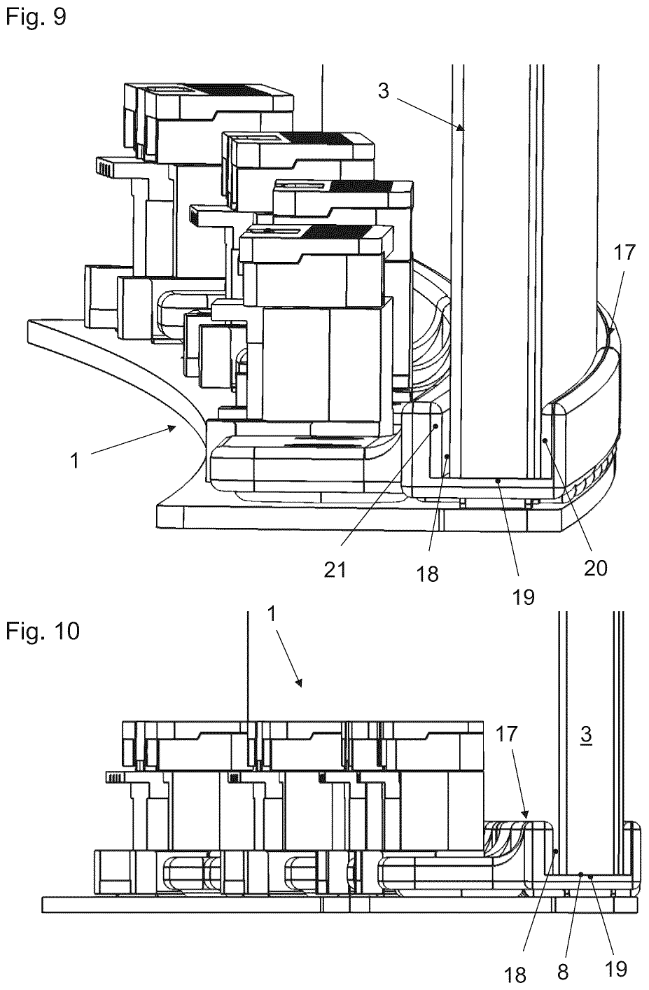

In the embodiments shown herein, the lighting device 1 and the waveguide 3 are curved along the length L of the waveguide (see FIG. 2 and FIG. 6, by way of example). This allows the lighting device 1 in the form of a tail lamp to be fitted to the shape of the rear of a motor vehicle. The receiver 18 fits the curvature of the waveguide 3. The sides 20, 21 can extend over the entire length of the waveguide 3 on the outer sides of the waveguide 3, or bear on the cover panel 11 and/or the reflective surface 13, and secure them in place.

The device 17 for positioning and/or retaining the waveguide 3, in particular the receiver 18, has at least two outer surfaces.

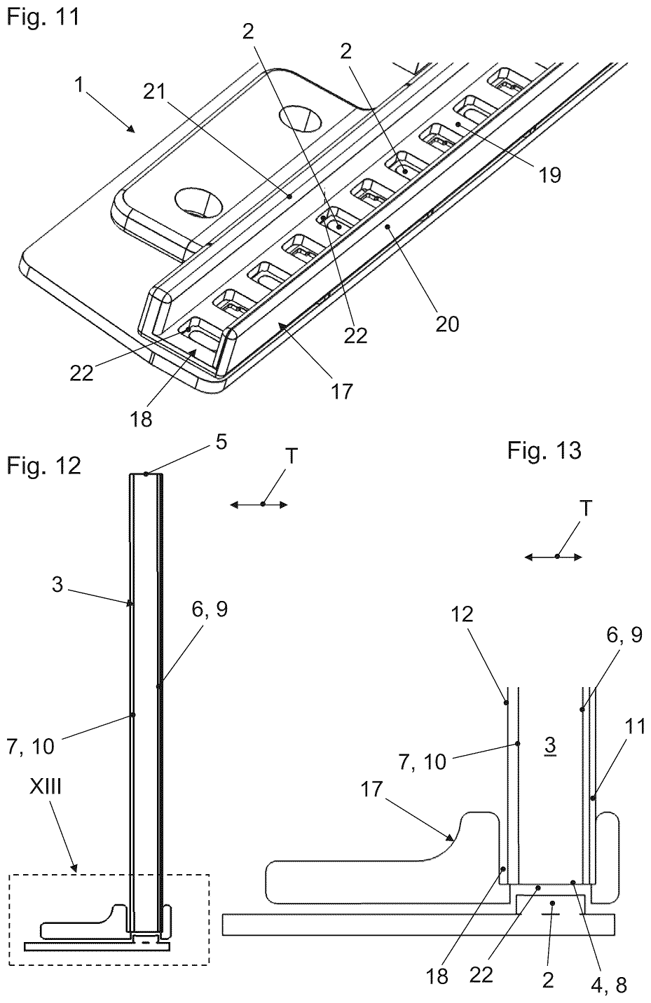

The light sources 2 are on a printed circuit board underneath the entry surface 8 and underneath the floor 19 of the receiver 18. The floor 19 has numerous holes 22 that allow the light from the light sources 2 to enter the entry surface 8, which are adjacent to and spaced apart from one another along the length of the waveguide (see FIG. 11 and FIG. 13). Each of the light-emitting diode light sources 2 has a dedicated hole 22. Parts of the printed circuit board can bear on the floor 19 from below.

The cut through one of these holes 22 in FIG. 13 shows that the light source 2 extends partially into the hole 22 from below. By placing the entry surface on the floor 19 of the receiver 18, and placing the light sources 2, or printed circuit board, against the floor 19 from below, the distance from the light sources 2 to the entry surface 8 can be precisely defined. The distance from the light sources 2 to the entry surface 8 can be between 0.2 mm and 0.5 mm, for example.

### LIST OF REFERENCE SYMBOLS

1 lighting device
2 light source
3 waveguide
4, 5 narrow surfaces of the wave guide along the length thereof
6, 7 wide surface of the wave guide along the length thereof
8 entry surface on the waveguide
9, 10 light emission surfaces on the waveguide
11 cover panel
12 reflective surface
13, 14 end surfaces of the waveguide
15 housing
16 projection on the housing
17 device for positioning and/or retaining the waveguide
18 receiver
19 floor of the receiver
20, 21 sides of the receiver
22 holes in the floor
L length
Q width
T depth

1. A lighting device for a motor vehicle, the lighting device comprising:
a flat waveguide with a length (L), width (Q) and depth (T), wherein the length (L) of the waveguide is greater than the width (Q), and the width (Q) is greater than the depth (T), wherein the waveguide has an entry surface and at least one light emission surface, wherein the length (L) of the waveguide is greater than 30 cm;
a plurality of light sources, wherein at least some light generated by the light sources enters the waveguide through the entry surface, at least some of the light entering through the entry surface exits the at least one light emission surface, and at least part of the light exiting the at least one light emission surface exits the lighting device; and
a device positioning and/or retaining the waveguide, wherein the device contains a receiver for a narrow surface of the waveguide extending along the length (L) of the waveguide.

2. The lighting device according to claim 1, wherein the length (L) of the waveguide is greater than 50 cm, wherein the lighting device extends over most of the width of the motor vehicle when installed thereon.

3. The lighting device according to claim 1, wherein the receiver is in the shape of a trough, with a floor and two sides.

4. The lighting device according to claim 1, wherein the waveguide is curved along its length (L), and the receiver fits the curvature of the waveguide.

5. The lighting device according to claim 1, wherein the waveguide has two end surfaces, two narrow surfaces over its length (L), and two wide surfaces over its length (L),
wherein the entry surface of the waveguide is formed on one of the narrow surfaces of the waveguide, and wherein the light sources are adjacent to one another over the length (L) of the waveguide.

6. The lighting device according to claim 5, wherein the at least one light emission surface on the waveguide is formed on one of the wide surfaces of the waveguide.

7. The lighting device according to claim 5, wherein the receiver is on the narrow surface of the waveguide where the entry surface is also formed.

8. The lighting device according to claim 1, wherein the light sources are light-emitting diodes on a printed circuit board.

9. The lighting device according to claim 1, wherein the device for positioning and/or retaining the waveguide has at least partially white outer surfaces.

10. The lighting device according to claim 3, wherein there are holes in the floor of the receiver.

11. The lighting device according to claim 1, wherein the distance from the light sources to the entry surface on the waveguide is defined by the receiver.

12. The lighting device according to claim 10, wherein the light sources bear in part on the floor of the receiver and/or extend into the holes in the floor of the receiver.

13. The lighting device according to claim 1, wherein the lighting device has a cover panel, wherein at least part of the light exiting the waveguide through the at least one light emission surface exits the lighting device through the cover panel.

14. The lighting device according to claim 1, wherein the lighting device has at least one microstructured film and/or at least one microstructured optical panel, wherein the at least one microstructured film or at least one microstructured optical panel is also partially located in the receiver.

15. The lighting device according to claim 1, wherein the lighting device has an at least partially reflective surface which is on the side of the waveguide facing away from the cover panel, wherein the light exiting the light emission surface of the waveguide facing away from the cover panel strikes the reflective surface, is reflected back to the light emission surface, and at least partially reenters the waveguide before it exits the light emission surface facing the cover panel and passes through the at least one cover panel, wherein part of the reflective surface is also located in the receiver in the form of a trough.

16. The lighting device according to claim 3, wherein the floor faces the narrow surface of the waveguide, wherein the floor bears on the narrow surface of the waveguide.

17. The lighting device according to claim 6, wherein a light emission surface is formed on each of the wide surfaces of the waveguide.

18. The lighting device according to claim 10, wherein each of the light sources has a dedicated hole such that the light from the light sources passes through its dedicated hole, and enters the entry surface of the waveguide.

19. The lighting device according to claim 11, wherein the distance from the light sources to the entry surface is between 0.1 mm and 1.0 mm.
